(19) United States
(12) Patent Application Publication
(10) Pub. No.: US 2021/0192947 A1
(43) Pub. Date: Jun. 24, 2021

(54) SERVICE INFORMATION ABOUT DATA STREAMS PROVIDED TO TRAFFIC PARTICIPANTS

(71) Applicant: Telefonaktiebolaget LM Ericsson (publ), Stockholm (SE)

(72) Inventors: Tim LAUTERBACH, Kerkrade (NL); Sander MAAS, Bavel (NL)

(21) Appl. No.: 16/080,519

(22) PCT Filed: Mar. 18, 2016
(86) PCT No.: PCT/EP2016/055964

§ 371 Date: Aug. 28, 2018

(51) Int. Cl. G08G 1/09; G08G 1/01; G08G 1/0968; H04L 29/06; H04W 4/46

(52) U.S. Cl. CPC G08G 1/093; G08G 1/0125; H04W 4/46; H04L 65/4076; H04L 65/608; G08G 1/0968

(57) ABSTRACT

The invention relates to a service information entity configured to provide information about a data stream provided to a traffic participant. The service information entity comprises a memory and at least one processor. The memory contains instructions executable by said at least one processor, wherein the service information entity is operative to carry out the following steps: Service information indicating which kind of service the data stream is providing is stored and interface information is stored about at least two interfaces with which the data stream is offered to the traffic participant, wherein the at least two interfaces differ from one another in at least one interface parameter describing how the data stream is transmitted to the traffic participant. Furthermore, the service information which kind of service the data stream is providing and the interface information about the at least two interfaces to the traffic participant is exposed.

### TECHNICAL FIELD

The present invention relates to a service information entity configured to provide information about a data stream provided to a traffic participant, and to the corresponding method for operating the service information entity. The invention furthermore relates to a communication device receiving the data stream and receiving information about the data stream and to a method for operating the communication device. Further, a computer readable storage medium is provided and a system comprising the service information entity and the communication device.

### BACKGROUND

In many countries traffic lights are interconnected or will be interconnected in the near future. This means that their real-time status can be broadcast to vehicles, e.g. at a frequency of 10 times per second. This information may be broadcast via Wi-Fi-p (IEEE 802.11p), but also via LTE networks.

The broadcast information may comprise the current light setting and a queue estimation and a short term plan such as the time to green or time to red. A typical packet size for one traffic light may be around 170 bytes.

FIG. 1 shows such a scenario in which a vehicle 10 approaches traffic lights 20 which broadcast the information using Wi-Fi technology using e.g. DSRC (Dedicated Short Range Communication).

The information could furthermore comprise a topology map of the intersection that shows what lane is related to what message. Connecting these traffic lights, which offer real-time flow of data, allow more devices and vehicles to consume this kind of service. However the service about traffic lights is only one example, other examples exist where it would be beneficial to provide a traffic participant with information such as the amount of parking spaces in the neighborhood, actual gas prices etc.

Another example could comprise traffic-related infrastructure parameters provided by broadcast information, such as the traffic density in the neighborhood and the local traffic situation around the traffic participants (often called the Local Dynamic Map or LDM). These different pieces of information may be provided by different applications, e.g. an ITS (Intelligent Transport Service) application. Another example could comprise city-related information, such as the available parking places in the parking lots of the city, or fuel price information of the gasstations in the proximity, or the location and availability of charging stations for charging electrical vehicles.

Also non-traffic related information may be provided to traffic participants. For example, information that a certain company is open and can be reached by taking the next exit, or ads/commercials that give a discount to traffic participants if they will visit the company today.

In providing this information to a traffic participant different questions have to be solved, such as how the traffic participant can discover that a local application is offering the information in a data stream. All these applications provide a more or less real-time data stream which may be received by a communication device of the traffic participant. Depending on the fact which communication device is used by the traffic participant and by which technology the information is offered, it may be important what consequences the reception of the corresponding data stream has for the traffic participant. By way of example if the data volume is very high, the traffic participant may have to pay for data received above a certain volume threshold if a certain transmission technology is used for the transmission, e.g. a cellular network.

### SUMMARY

Accordingly, a need exists to provide a possibility to effectively inform a traffic participant about different options in a scenario mentioned above, especially which options exist to receive the data stream and which bandwidth will be used to receive it.

This need is met by the features of the independent claims. Further aspects are described in the dependent claims.

According to a first aspect a service information entity is provided configured to provide information about a data stream provided to a traffic participant. The service information entity comprises a memory and at least one processor, the memory containing instructions executable by said at least one processor. The service information entity is operative to store service information indicating which kind of service the data stream is providing and store interface information about at least two interfaces with which the data stream is offered to the traffic participant. The at least two interfaces differ from one another in at least one interface parameter describing how the data stream is transmitted to the traffic participant. Furthermore, the service information which kind of service the data stream is provided, and the interface information about at least two interfaces is exposed to the traffic participant.

Additionally, a service information entity is provided configured to provide information about a data stream provided to a traffic participant. The entity comprises a memory configured to store service information indicating which kind of service the data stream is providing and store interface information about at least two interfaces with which the data stream is offered to the traffic participant. The at least two interfaces differ from one another in at least one interface parameter describing how the data stream is transmitted to the traffic participant. The service information entity additionally comprises an interface configured to expose the service information and interface information to the traffic participant.

With the above described service information entity the traffic participant has a clear picture what kind of service a data stream provides. He or she receives information about the possible interfaces with which the data stream can be received. Based on this information the traffic participant can decide whether the service is used and what the best configuration settings are (for example, to minimize costs or optimize performance) i.e. whether the data stream should be received and by which interface the data stream should be received.

Furthermore, a method for operating the service information entity is provided which provides information about the data stream provided to the traffic participant wherein the method comprises the steps discussed above for the service information entity.

According to another aspect a communication device is provided configured to receive a data stream provided to a traffic participant and configured to receive information about the data stream. The communication device comprises a memory and at least one processor, the memory containing instructions executable by said at least one processor, wherein the communication device is operative to receive, from the service information entity, service information indicating which kind of service the data stream is provided. Furthermore, interface information is received about at least two interfaces with which the data stream is received at the communication device, wherein the at least two interfaces differ from one another in at least one interface parameter describing how the data stream is transmitted to the communication device. Furthermore, a criterion is determined upon which it is decided which of the at least two interfaces is used to receive the data stream. One of the at least two interfaces is selected for the reception of the data stream based on the determined criterion and the data stream is received with the selected interface.

Additionally a communication device is provided comprising a receiver configured to receive a data stream provided to a traffic participant and configured to receive information about the data stream. The interface is further configured to receive, from a service information entity, service information indicating which kind of service the data stream is provided and interface information about at least two interfaces with which the data stream is received at the communication device, wherein the at least two interfaces differ from one another in at least one interface parameter describing how the data stream is transmitted to the communication device. Furthermore, a control unit of the communication device is configured to determine a criterion upon which it is decided which of the at least two interfaces of the interface information is used to receive the data stream and to select one of the at least two interfaces based on the criterion, the selected interface receiving the data stream.

With the communication device a traffic participant using the communication device can determine how the data stream is received. Based on different criteria the communication device can determine the interface that is used for the reception so that amongst other things a data volume of the received data stream can be controlled in a better way.

Additionally, a method for operating the communication device mentioned above is provided which carries out the step mentioned above in connection with the communication device.

Furthermore, a computer readable storage medium is provided having stored thereon a computer program, wherein execution of the computer program by at least one processor of the service information entity causes the at least one processor to execute a method for providing information about a data stream provided to a traffic participant. The method comprises the steps of storing service information indicating which kind of service the data stream is providing and storing interface information about at least two interfaces with which the data stream is offered to the traffic participant, wherein the at least two interfaces differ from one another in at least one interface parameter describing how the data stream is transmitted to the traffic participant. Furthermore, the service information which kind of service the data stream is providing and the interface information about the at least two interfaces is exposed to the traffic participant.

Furthermore, a computer readable storage medium having stored thereon a computer program is provided wherein execution of the computer program by the at least one processor of a communication device causes the at least one processor to execute a method for operating the communication device which is configured to receive a data stream provided to a traffic participant and configured to receive information about the data stream. The method comprises the step of receiving, from a service information entity, service information indicating which kind of service the data stream is providing and interface information about at least two interfaces with which the data stream is received at the communication device, wherein the at least two interfaces differ from one another in at least one interface parameter describing how the data stream is transmitted to the communication device. One of the at least two interfaces is selected for the reception of the data stream based on the determined criterion. Furthermore, the data stream is received with the selected interface.

Furthermore, a system is provided comprising the service information entity and communication device mentioned above.

It is to be understood that the features mentioned above and features yet to be explained below can be used not only in the respective combinations indicated, but also in other combinations or in isolation without departing from the scope of the present invention. Features of the above-mentioned aspects and embodiments may be combined with each other in other embodiments unless explicitly mentioned otherwise.

### BRIEF DESCRIPTION OF THE DRAWINGS

The foregoing and additional features and effects of the application will become apparent from the following detailed description when read in conjunction with the accompanying drawings in which like reference numerals refer to like elements.

FIG. 1 shows a situation where a traffic participant approaches a traffic light equipped with a short range communication technology in order to provide information about the current settings as known in the art.

FIG. 2 shows a schematic view of an example system in which a traffic participant is informed about the different services and possible interfaces incorporating features of the invention.

FIG. 3 schematically shows an example table indicating an overview of the information provided by the service information entity of FIG. 2.

FIG. 4 shows a further example table indicating possible interfaces which could be used to transmit the data stream to a traffic participant.

FIG. 5 shows an example of messages exchanged between some of the entities shown in FIG. 2 indicating how a traffic participant can decide how a data stream is provided to the traffic participant.

FIG. 6 shows an example of messages exchanged between involved entities in a situation where the source for providing the data stream is changed during reception.

FIG. 7 shows an example flowchart of a method carried out by the service information entity of FIG. 2 in order to provide the service information to the traffic participant.

FIG. 8 shows an example flowchart of a method carried out by a communication entity receiving the service information from the service information entity.

FIG. 9 shows an example schematic representation of a service information entity configured to provide the service information to the traffic participant.

FIG. 10 shows another example schematic representation of a service information entity providing service information to a traffic participant.

FIG. 11 shows an example schematic representation of a communication entity configured to receive the service information from the service information entity.

FIG. 12 shows another example schematic representation of a communication entity receiving the service information from the service information entity.

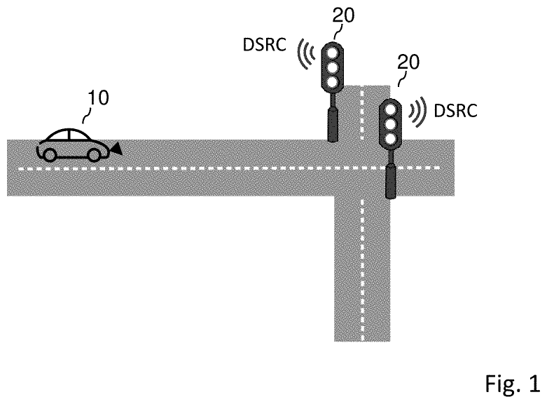

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

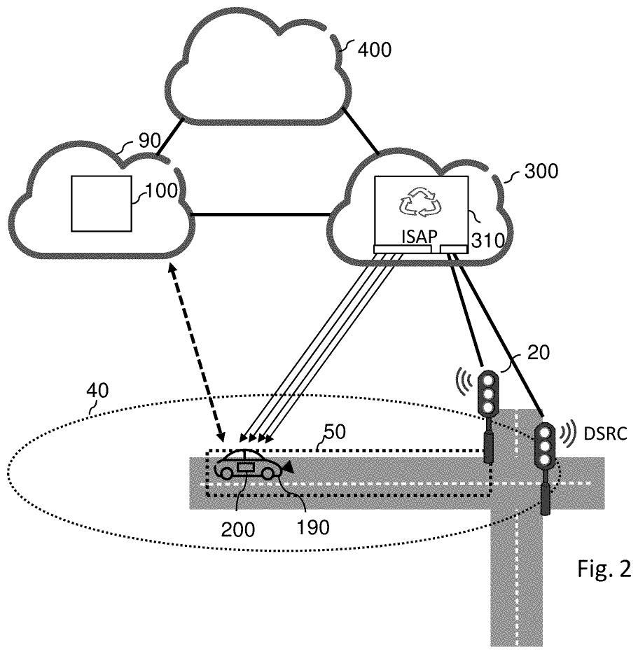

FIG. 2 provides an overview over a system in which a traffic participant, e.g. a mobile communication device 200 of the traffic participant 190 receives information about a service. The communication device 200 can be a mobile phone, a portable computer device, a PDA (Portable Digital Assistant), a stationary computer device or any other kind of wirelessly connected device. A traffic participant can include any kind of vehicle and a user of the vehicle which also uses the communication device. The traffic participant is any person moving on any kind of road for which traffic related information may be of interest, be it a user of a car, of a bicycle or a pedestrian A service information entity 100 of a service provider 90 is an entity that is aware about services to the end users, here the traffic participants 190. In the present examples described below the service information entity provides service information to the traffic participants, namely which kind of services a traffic participant can receive and information about different interfaces with which the service can be received. The service provided is a data stream or real-time data stream provided by an application such as for example a traffic light application which informs the traffic participants about the current settings of traffic lights 20 shown in FIG. 2. Other examples of services are the amount of parking spaces in the neighborhood, actual gas prices, prices of a store and discounts provided by a store located in the neighborhood et cetera. Furthermore, the service may provide a data stream of traffic density messages informing the traffic participant about the traffic density in the neighborhood. The data stream may be provided, depending on the interface, with a frequency between 0.5 Hz and 10 Hz, thus in a range between 2 times per second and 10 times per second.

The content, the data stream, is then provided by content provider 300 which in the example shown comprises an access point 310 which in the example shown is an ITS streaming access point (ISAP). Alternatively the content may be provided directly by the traffic light 20. A service broker 400 is an entity or organization that tries to orchestrate between the content provider 300 and the service provider 90 including the service information entity. The service broker 400 can provide a discovery mechanism, e.g. a service directory that lists the number of services that are available, by way of example a web page. In some examples the role of the service broker may be obsolete when the service provider 90 can deliver the whole service end-to-end. Furthermore, one organization can assume one, several, or all the roles of content provider 300, service provider 90 and service broker 400. Furthermore, a target dissemination area 40 is shown where the service of the data stream can be received by the traffic participant 190. In addition to the target dissemination area 40, a relevance area 50 is shown where the service of the data stream is actually applicable. In case of the example shown concerning the traffic lights 20, the relevance area 50 may be the area such as 100 m in front of the corresponding traffic light in a certain direction, e.g. in the northern direction. Furthermore, the relevance area may indicate a line on the traffic map to which the dataflow of the service can relate. By way of example, the service may only specify the traffic light phases of a traffic light which is only valid for a certain lane such as a turn lane. The service information entity 100 will describe which type of service an application is offering. The information provided can comprise one of the following items:
The class of the service, e.g. the traffic light, the parking service, the fuel service,
the location of the service, e.g. GPS position of the traffic light,
the relevance area 50 of the service, e.g. 100 m in front of the traffic light in a certain direction,
the target dissemination area 40 of the service, e.g. proximity of 1 km of the traffic light.

Furthermore, an interface description is provided comprising at least one of the following items:
The address, where to find the interface that exposes the service. The address may be a URL address and channel information for MQTT, (Message Queuing Transfer Protocol, ISO standard (ISO/IEC PRF 20922)),
the communication protocol, describing which communication protocol is used, information about a radio access technology type of the interface, such as WiFi, 3G, LTE, 5G,
a transport and network protocol indicating which transport protocol is used, for example TCP/IP or GeoNetworking (GN) and Basic Transport Protocol (BTP) (part of ETSI ITS G5),
the used application layer protocol indicating how the content is encoded or formatted. The application layer protocol may comprise message protocols, e.g. SPAT (Signal Phase and Timing),
a bandwidth information indicating a frequency with which the data stream is received and/or a data volume per time period of the received data stream,
a security information indicating how the interface should be accessed, by way of example with a user ID or a password as necessary. This may be relevant for applications such as a request for priority at traffic lights for emergency vehicles. But also when the traffic participant is carpooling and/or has multiple passengers to get priority,
Payment details for the service, including the rated price per interface configuration, based on a predefined contract with the service provider. This may require that the identity from the user is known by the service provider. For example, receiving the message over WiFi-p may be free of charge, and receiving the message over LTE at 2 times per second is more expensive than receiving it 1 time per second.

With the information provided by the service information entity 100, a client such as a traffic participant 190 can easily discover the provided services such as ITS services and identify which type of interfaces are being exposed. By processing the interface definition, it is possible to decide which type of interface is better suited depending on some criteria which can include the location of the traffic participant, requirements on content frequency, SLA (Service Level Agreement) on Quality-of-Service (QoS) levels. The service consumers, such as the traffic participants 190 and the used communication device 200, are able to discover location-based applications. The traffic participant 190 is able to select the desired interface he/she wants to use based on a service information or interface information provided above. The criterion which of the interfaces should be selected for the reception of the data stream may comprise features such as the ITS service class, the location of the ITS application (this refer to the geographical position of the traffic light, and can be represented in several coordinate systems such as longitude/latitude (GPS system), or WGS84 which is typically used by road operators in Europe), the relevance area of the ITS application, the target dissemination area and interface details.

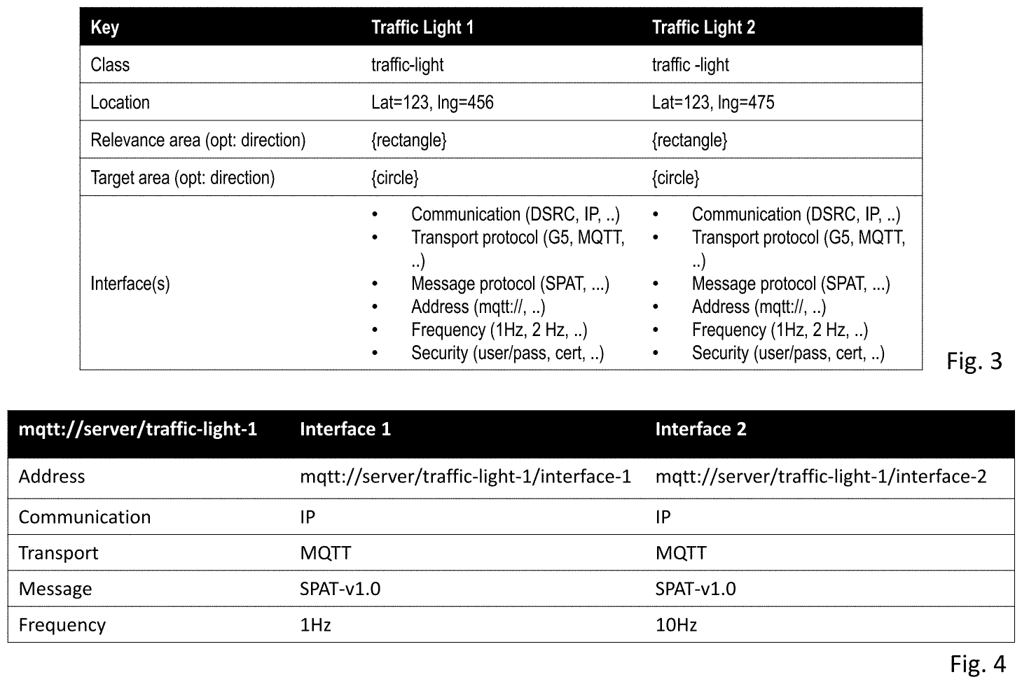

FIG. 3 is a summary of information that may be provided by the service information entity 100. FIG. 4 shows a simple description of two interfaces for a connected traffic light. In the example shown the data is exposed on dedicated MQTT channels. The format of the payload is SPAT in version 1.0. Depending on the interface the traffic participant chooses, he or she can for example expect up to 10 messages per second. In the example shown the interface is not protected and anybody could subscribe to these channels.

Returning to FIG. 2, an example is explained how a traffic light 20 can be connected to the service information entity. An operator of the connected traffic lights could register the traffic light service at the service provider 90. The clients are able to discover the traffic light service upon request or the service provider could expose information about the traffic light service to the traffic participants which are in the proximity such as the target dissemination area 40. The operator of the traffic light may register the connected traffic lights at the service provider 90. A complete description, including the interface description will be provided as shown in FIGS. 3 and 4 mentioned above. In the example of FIGS. 3 and 4, for one traffic light two interfaces are registered. For instance, on interface 1 the frequency of the messages could be 1 Hz, whereas an interface 2 the frequency could be 10 Hz as indicated in FIG. 4.

The service provider 90 saves the information and exposes it to the traffic participants so that the traffic participants can discover the traffic light service. Either the information is exposed upon request by this traffic participant or actively pushed to the traffic participants, for instance if they are in the target dissemination area 40 of the traffic light. A subscribe mechanism where the traffic participants can actively indicate an interest only in traffic lights could filter out other information.

Upon entering the target dissemination area 40 the traffic participant 190 receives the traffic light service information. The traffic participant can process the information and is able to decide if he or she would like to consume the service and, if so, on which interface.

Upon entering the relevance area 50 the communication entity 200/traffic participant 190 could consume the service on the earlier chosen interface or switch to a different interface. Also a different interface may be chosen when the traffic participant gets closer to the traffic light, for example to get an update 1 times per second when the distance is less then 200 meters and 10 times per second when the distance is less than 100 meter. Here, the application could receive real-time information about the phase of the traffic light and instruct the driver to maintain a certain speed to make the green light.

It is possible that different interface configurations may have different relevance areas and dissemination areas, e.g. in view of different communication ranges between different transmission technologies such as cellular transmission and WiFi-p.

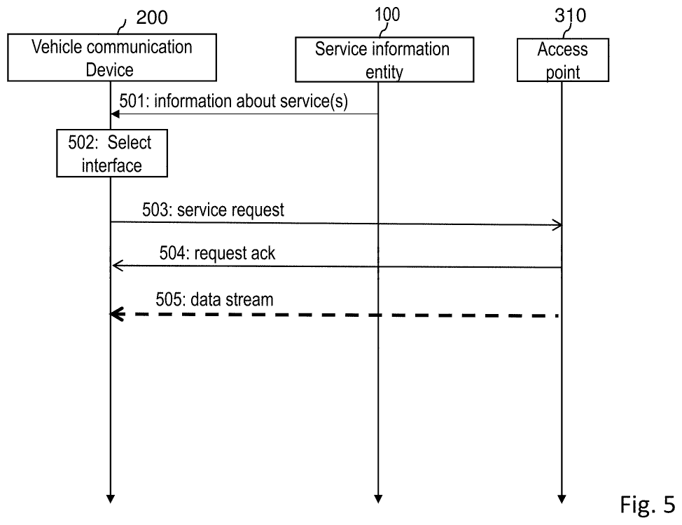

FIG. 5 shows an example message flow indicating how the traffic participant, i.e. the communication device 200 provided in the vehicle of the traffic participant 190 can receive the data stream. In step 501, the service information entity 100 informs the communication device 200 about the service information and information about the interfaces, such as the service and interface information indicated in FIGS. 3 and 4 and discussed in more detail above. In step 502, the vehicle communication device 200 can select an interface which should be used for a reception of the data stream. This interface selection can be carried out automatically based on one or more predefined criterion such as the service class, the location of the service, a required bandwidth et cetera. In another embodiment, the user of the communication device is informed about the provided services and the provided interfaces and the user will actively select one of the provided services and one of the interfaces.

By way of example, the information about the different services and the corresponding interfaces may be shown on a display of the communication device 200. In step 503, a service request is transmitted to the access point 310 indicating which service the traffic participant would like to consume and on which interface. This message is transmitted to the access point 310 which can provide the content in the data stream with the selected interface. In step 504, the request is acknowledged and the access point 310 can start in step 505 to deliver the real-time data stream at the required bandwidth selected by the interface selection.

Furthermore, it is possible that the traffic participant 190 sends a request to the service information entity 100 requesting whether the service can be provided via a specific interface which does not correspond to a currently used interface and/or does not correspond to one of the interfaces provided by the interface information.

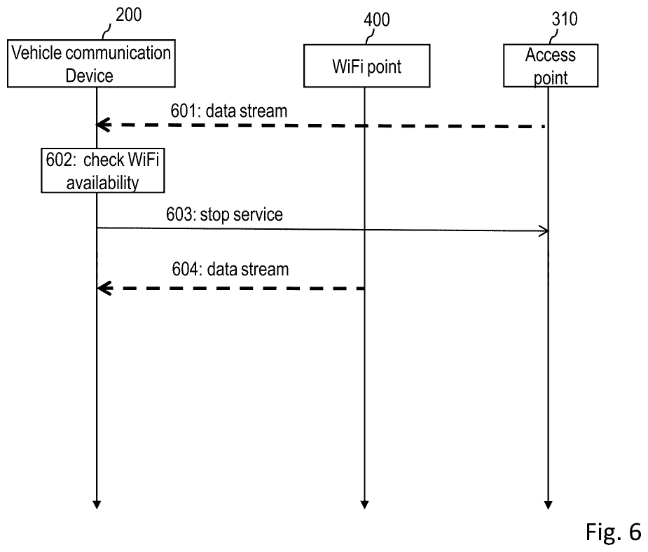

FIG. 6 shows an example in which the interface used for the transmission for the data stream is changed, e.g. based on the location of the traffic participant. In the first step 601, the data stream is provided by the access point 310 as already discussed above in connection with FIG. 5. As the corresponding traffic light to which the service relates is located at a greater distance, a cellular network as first interface technology may be used to transmit the data to the traffic participant. The vehicle communication device may check in step 602 whether Wi-Fi access technology is available. Step 602 may be carried out continuously as long as the data stream is received with the first interface technology of step 601. Alternatively the vehicle communication device may have received service and interface information about the WiFi hot spot from the service provide, possibly also with information of the area covered by the WiFi hot spot. The communication device 200 may then determine that Wi-Fi technology is available (either by detecting the WiFi hot spot or by determining that it is located in an area covered by the WiFi hot spot) and can inform in step 603 the access point 310 that there is no need to continue the provision of the data stream. The data stream may also be directly provided by the traffic lights themselves as indicated by the signs in FIG. 2 next to the traffic lights. As soon as the Wi-Fi access technology is available the data stream may be transmitted to the communication device 200 using the Wi-Fi technology with a different interface. By way of example, the data stream transmitted in step 604 may be provided with a higher data rate than the data stream provided in step 601.

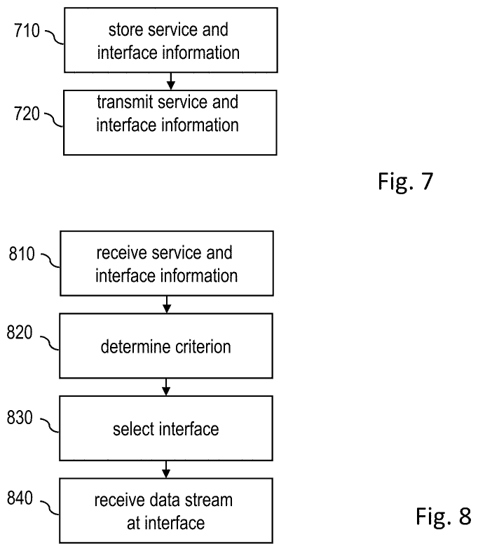

FIG. 7 summarizes the steps carried out by the service information entity 100. In a first step 710, the service information and interface information is stored at the service information entity. As discussed above, the service information indicates which kind of service is provided by the data stream and the interface information comprises the information which of the interfaces may be used for the reception of the data stream. In step 720, the service information and the interface information is then exposed to the traffic participant, either upon request by the traffic participant or it is pushed to the traffic participant.

FIG. 8 summarizes the steps carried out by communication device 200. In step 810, the exposed service and interface information is received from the service information entity. In step 820, the communication entity determines a criterion which of the interfaces should be used for the reception of the data stream. In step 830, one of the interfaces is selected. In step 840, the data stream is received at the selected interface. It should be understood that the steps discussed in connection with FIG. 8 are only carried out when the traffic participant has decided to use the provided service. If no service should be received, no interface is selected and no data stream is received.

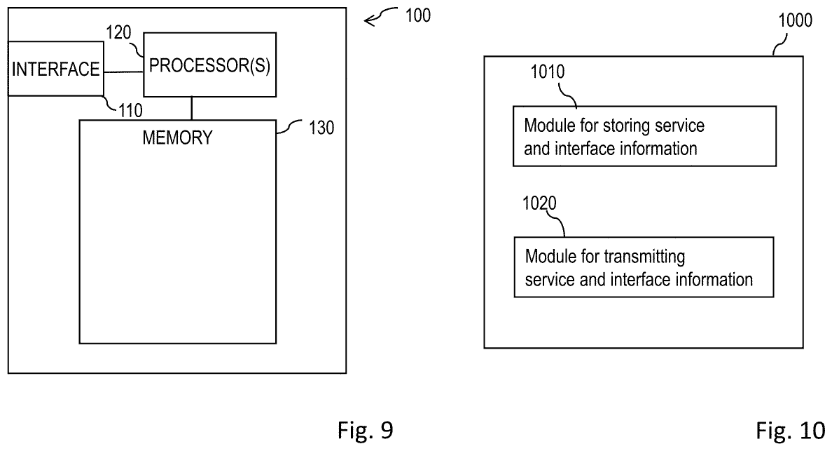

FIG. 9 is a schematic illustration of the service information entity 100. The service information entity 100 comprises an interface 110 via which the service information entity communicates with the other entities such as the traffic participant 190, the content provider 300 or the service broker 400 shown in FIG. 2. The service information entity 100 furthermore comprises one or more processor 120 which is responsible for the operation of the service information entity. The processor can be a multicore processor. The service information entity furthermore comprises a memory 130 which may store a program code that can be executed by the processing unit 120. Executing the program code can cause the service information entity or the processing unit 120 to perform techniques described above or below in which the service information entity is involved. Memory 130 can furthermore store the service information and interface information such as the tables indicated in FIGS. 3 and 4.

FIG. 10 shows a further embodiment of the service information entity. The service information entity 1000 comprises a module 1010 for storing the service information and the interface information. The module 1010 can collect the different pieces of information and store them in one or more tables. Module 1020 is provided for exposing service and interface information to the traffic participant.

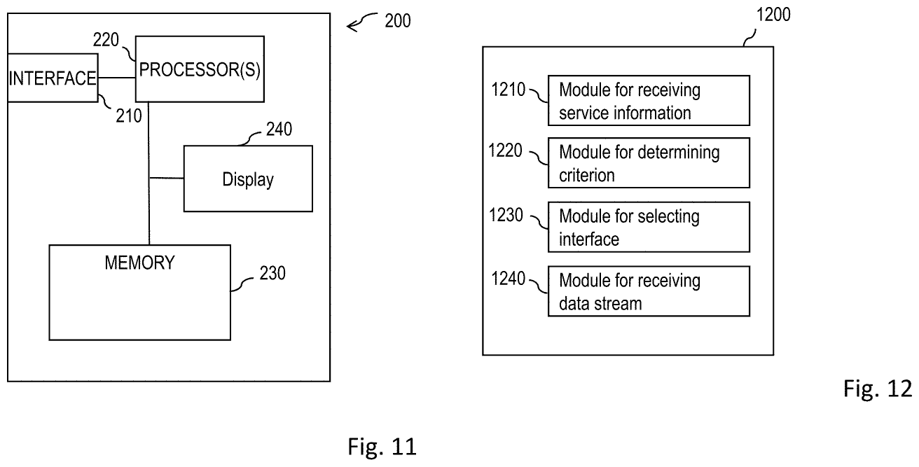

FIG. 11 shows a schematic view of a communication device 200. The communication device 200 comprises an interface 210 which is used for the communication with all the other entities such as the access point 310 and the service information entity 100. The communication device furthermore comprises one or more processors 220 which are responsible for the operation of the communication device. The communication device 200 furthermore comprises a memory 230 which can store the program code that can be executed by the at least one processor 220. Execution of the program code stored in memory 130 can cause the processor 220 to perform techniques described above or described in more detail below in which the communication device is involved. Furthermore, a display 240 may be provided where the received interface and/or service information may be displayed and which may be used by a user of the communication device to select one of the provided services and one of the corresponding interfaces. It should be understood that the communication device can comprise other functional modules needed for the operation of the communication device which are not shown for the sake of clarity.

FIG. 12 shows a further example of a communication device 1100. The communication device comprises a first module 1210 for receiving the service interface information. A second module 1220 is provided for determining a criterion which is used for the decision which of the interfaces should be used for the reception of the data stream if one of the services should be used. Module 1230 is provided for selecting one of the interfaces for the data transmission, and module 1240 is provided to finally receive the real-time data stream with the selected interface and thus with the selected bandwidth.

From the above said some general conclusions can be drawn.

As far as the service information entity is concerned, the provided service information can comprise at least one of the following items: a service class, the data stream is offering, a location where the data stream is offering the service, a relevance area such as relevance area 50 where the service of the data stream is applicable, and a target dissemination area 40 where the service of the data stream can be received by the traffic participant 190 or communication device 200.

The interface information received can comprise at least one of the following items: an interface address where the interface can be reached, an information about a radio access technology type of the interface, information about an interface network layer protocol, information about an interface transport protocol, information about an interface application protocol, a bandwidth information which can include a frequency with which the data stream is received and/or a data volume per time period of the received data stream. The interface information can furthermore include a security information indicating how the corresponding interface can be reached.

The service information entity 100 may be operative to push the service information and the interface information to the traffic participant.

By way of example, the service information and the interface information may be pushed to the traffic participant based on the target dissemination area.

Furthermore, the service information entity 100 may be operative to deliver the service information and the interface information to the traffic participant upon request. In this embodiment the traffic participant has to become active to receive the service information and interface information.

As far as the communication device 200 is concerned, it determines a criterion upon which it is decided which of the at least two interfaces is used to receive the data stream. The criterion may relate to a position of the communication device, wherein the communication device is operative to determine the position of the communication device and to select one of the at least two interfaces based on the determined position of the communication device 200. As explained above in connection with FIG. 6, different interfaces may be used in dependence on the location of the communication device 200 relative to the entity to which the service relates, here the traffic lights 20.

Furthermore, the criterion may relate to a bandwidth of the interface wherein the received interface information comprises a bandwidth information comprising at least one of a frequency with which the data stream is received and a data volume per time period of the received data stream. The communication device 200 may then select one of the interfaces based on the received bandwidth information.

The communication device 200 may furthermore comprise a display 240 where the interface information may be displayed for the at least two interfaces. The communication device may be operative to receive a feedback from the traffic participant using the communication device and select one of the interfaces for receiving the data stream wherein the data stream is received with the selected interface. Here, the criterion comprises the feedback from the traffic participant.

Furthermore, the communication device 200 may be able to change the selected interface in the relevance area 50 where the service to which the data stream relates is applicable based on a predefined criterion. The predefined criterion may correspond to the criterion determined and used for selecting the interface. However the “predefined criterion” and the “determined criterion” may also differ from one another. By way of example the interface is selected based on the determined criterion such as the position (e.g. when entering the relevance area), and the interface is then changed based (while still being in the relevance area) on the available radio technology, which in this example corresponds to the predefined criterion.

Furthermore, the communication device 200 may select, as a criterion, the fact whether the data stream can be received with a predefined transmission technology. The communication device may then select one of the at least two interfaces based on the fact whether the predefined transmission technology can be used for receiving the data stream.

Furthermore, it is possible that the interface parameter comprises an application layer protocol type and the criterion relates to the application layer protocol type.

The computer readable storage medium on which the computer programs are stored could be any computer readable signal medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Summarizing, the above described features allow a traffic participant to easily discover the services and to identify which type of interfaces may be used. The interface may be selected in dependence on the specific requirements of the traffic participant.

In the example above, the main field of application relates to ITS scenarios. However, it should be understood that the service information entity may provide information about the service information and the interface information relating to any service which is not related to a vehicle or traffic scenario but involves a traffic participant, like for example a media stream (e.g. video or audio) or information on local events such as available parking places, or fuel prices at gas stations.

1. A service information entity configured to provide information about a data stream provided to a traffic participant, the service information entity comprising a memory (130) and at least one processor 4, the memory containing instructions executable by said at least one processor, wherein the service information entity is operative to:
store service information indicating which kind of service the data stream is providing and store interface information about at least two interfaces with which the data stream is offered to the traffic participant, wherein the at least two interfaces differ from one another in at least one interface parameter describing how the data stream is transmitted to the traffic participant,
expose the service information which kind of service the data stream is providing and the interface information about the at least two interfaces to the traffic participant.

2. The service information entity according to claim 1, wherein the service information comprises at least one of the following: a service class the data stream is offering, a location where the data stream is offering the service, a relevance area where the service of the data stream is applicable, and a target dissemination area where the service of the data stream can be received by the traffic participant.

3. The service information entity according to claim 1, wherein the interface information comprises for each of the at least two interfaces, at least one of
an interface address, where the interface can be reached,
information about a radio access technology type of the interface,
information about a transport and network protocol,
information about a used application layer protocol,
a bandwidth information which comprises at least one of a frequency with which the data stream is received and a data volume per time period of the received data stream, and
a security information indicating how the corresponding interface can be reached.
Payment details for the service, including the rated price per interface configuration, based on a predefined contract with the service provider.

4. The service information entity according to claim 1, wherein the service information entity is operative to one of push the service information and the interface information to the traffic participant, and wherein the service information and the interface information is pushed to the traffic participant based on the target dissemination area, and deliver the service information and the interface information to the traffic participant upon request.

5.-6. (canceled)

7. A communication device configured to receive a data stream provided to a traffic participant and configured to receive information about the data stream, the communication device comprising a memory and at least one processor, the memory containing instructions executable by said at least one processor, wherein the communication device is operative to:
receive, from a service information entity, service information indicating which kind of service the data stream is providing, and interface information about at least two interfaces with which the data stream is received at the communication device wherein the at least two interfaces differ from one another in at least one interface parameter describing how the data stream is transmitted to the communication device,
determine a criterion upon which it is decided which of the at least two interfaces is used to receive the data stream,
select one of the at least two interfaces for the reception of the data stream based on the determined criterion,
receive the data stream with the selected interface.

8. The communication device according to claim 7, wherein the criterion relates to one or more of a position of the communication device wherein the communication device is operative to determine the position of the communication device and to select one of the at least two interfaces based on the determined position of the communication device, and/or a bandwidth of the interface wherein the received interface information comprises a bandwidth information comprising at least one of a frequency with which the data stream is received and a data volume per time period of the received data stream, wherein the communication device is operative to select one of the interfaces based on the received bandwidth information.

9. (canceled)

10. The communication device according to claim 7, further comprising a display, wherein the communication device is operative to display the interface information for the at least two interfaces, the communication device being operative to receive a feedback from the traffic participant using the communication device and selecting one of the interfaces for receiving the data stream, and to receive the data stream with the selected interface, wherein the criterion comprises the feedback from the traffic participant.

11. The communication device according to claim 7, wherein the communication device is operative to change the selected interface in a relevance area where the service to which the data stream relates is applicable based on a predefined criterion, and/or wherein the communication device is operative to select, as a criterion, the fact whether the data stream can be received with a predefined transmission technology, and is operative to select one of the at least two interfaces based on the fact whether the predefined transmission technology can be used for receiving the data stream.

12. (canceled)

13. The communication device according to claim 7, wherein the interface parameter comprises an application layer protocol type, and wherein the criterion relates to the application layer protocol type.

14. The communication device according to claim 7, wherein the communication device is operative to transmit a request to the service information entity whether the data stream could be received via a predefined interface.

15. A method for operating a service information entity providing information about a data stream provided to a traffic participant, comprising the steps of
storing service information indicating which kind of service the data stream is providing and storing interface information about at least two interfaces with which the data stream is offered to the traffic participant, wherein the at least two interfaces differ from one another in at least one interface parameter describing how the data stream is transmitted to the traffic participant,
exposing the service information which kind of service the data stream is providing and the interface information about the at least two interfaces to the traffic participant.

16. The method according to claim 15, wherein the service information and the interface information is pushed to the traffic participant, and/or wherein the service information and the interface information is pushed to the traffic participant based on a target dissemination area where the service of the data stream can be received by the traffic participant.

17. (canceled)

18. The method according to claim 15, wherein the service information and the interface information is transmitted to the traffic participant upon a request received from the traffic participant.

19. A method for operating a communication device which is configured receive a data stream provided to a traffic participant and configured to receive information about the data stream, comprising the steps of:
receiving, from a service information entity, service information indicating which kind of service the data stream is providing, and interface information about at least two interfaces with which the data stream is received at the communication device wherein the at least two interfaces differ from one another in at least one interface parameter describing how the data stream is transmitted to the communication device,
determining a criterion upon which it is decided which of the at least two interfaces is used to receive the data stream,
selecting one of the at least two interfaces for the reception of the data stream based on the determined criterion,
receiving the data stream with the selected interface.

20. The method according to claim 19, wherein the criterion relates to one or more of a position of the communication device with the method further comprising determining the position of the communication device wherein one of the at least two interfaces is selected based on the determined position of the communication device and/or a bandwidth of the interface wherein the received interface information comprises a bandwidth information comprising at least one of a frequency with which the data stream is received and a data volume per time period of the received data stream wherein one the interfaces is selected based on the received bandwidth information.

21. (canceled)

22. The method according to claim 19, wherein the communication device further comprises a display, wherein the interface information for the at least two interfaces is displayed on the display and feedback is received from the traffic participant using the communication device and selecting one of the interfaces for receiving the data stream, wherein the data stream is received with the selected interface, wherein the criterion comprises the feedback from the traffic participant.

23. The method according to claim 19, wherein the selected interface is changed based on a predefined criterion in a relevance area where the service to which the data stream relates is applicable.

24. The method according to claim 19, wherein it is checked whether the data stream can be received with a predefined transmission technology, wherein one of the at least two interfaces is selected based on the fact whether the predefined transmission technology can be used for receiving the data stream.

25. A computer readable storage medium, having stored thereon a computer program, wherein execution of the computer program by at least one processor of a service information entity causes the at least one processor to execute a method according to claim 15.

26. A computer readable storage medium, having stored thereon a computer program, wherein execution of the computer program by at least one processor of a communication device causes the at least one processor to execute a method according to claim 19.

27. (canceled)
